(19) United States
(12) Patent Application Publication
(10) Pub. No.: US 2004/0123037 A1
(43) Pub. Date: Jun. 24, 2004

(54) Interconnect structure including write and read structures

(76) Inventors: Wilfred Gomes, Hillsboro, OR (US); Terry I. Chappell, Portland, OR (US); Thomas D. Fletcher, Portland, OR (US)

Correspondence Address: Buckley, Maschoff, Talwalker & Allison LLC, Five Elm Street, New Canaan, CT, 06840, US

(21) Appl. No.: 10/326,766

(22) Filed: Dec. 20, 2002

(51) Int. Cl. G06F 12/00

(52) U.S. Cl. 711/131

(57) ABSTRACT

According to some embodiments, an interconnect structure includes write and read structures.

### BACKGROUND

An integrated circuit may use an interconnect structure to store, retrieve, and/or transfer information. For example, a processor may store information in a register file structure having a number of information cells (e.g., eight cells) via a write port. Similarly, the processor may retrieve information from the register file structure via a read port. In some processors (e.g., a superscalar processor that executes more than one instruction during a processor cycle), the register file structure may have multiple write and/or read ports.

FIG. 1 is a diagram of a known register file structure 100. In particular, the register file structure 100 includes eight information cells 110. Each information cell 110 includes a write port and five read ports (P1 through P5). That is, the information in the cell 110 can be retrieved via any of the five read ports.

The register file structure 100 also includes six bitlines that may be used to store information into, or retrieve information from, the register file structure 100 (i.e., one bitline provides information via the write port and each of the other five bitlines receives information from one of the five read ports). Similarly, six wordlines for each of the information cells 110 are used to select a particular port when storing information into, or retrieving information from, the register file structure 100 (i.e., each wordline selects one of the write or read ports).

As a result, the register file structure 100 grows with N*N (where N is a function of the total number of write and read ports combined). This may result in an exponential increase in area costs (as well as power and latency problems) as the value of N increases. Moreover, the design may have cells 110 that match the array bit-slice column height associated with the metal pitch required for N bitlines in a wire-limited design. That is, adding ports (i.e., write and/or read ports) may cause the register file structure 100 to grow in both height and width. Although array folding might be used to stack multiple columns and alter the aspect ratio (e.g., to better fit a floor plan), such an approach will not decrease the area of the register file structure 100. Moreover, it may be difficult to apply such an approach to a multi-ported structure since the increased height of the array can make the wordline resistance inappropriate for high speed applications.

Another disadvantage with the traditional design of an interconnect structure is that a design may need to be customized based on a particular number of write and/or read ports, increasing the design time and expense associated with the structure. For example, a structure having two write ports and six read ports cannot be easily modified to support two write ports and eight read ports. Note that the total number of required designs is associated with the cross product of the number of possible write ports and the number of possible read ports. For example, if there may be between one and five write ports and one and five read ports, a total of twenty five different structures may need to be designed.

### BRIEF DESCRIPTION OF THE DRAWINGS

FIG. 1 is a diagram of a known register file structure.

FIG. 2 is a block diagram of a memory structure according to some embodiments.

FIG. 3 is a diagram of a register file structure according to some embodiments.

FIG. 4 is a flow chart of a method of storing information according to some embodiments.

FIG. 5 is a flow chart of a method of retrieving information according to some embodiments.

FIG. 6 is a block diagram of a system that includes an integrated circuit with a memory structure according to some embodiments.

FIG. 7 illustrates a register file and associated arithmetic-logic units according to some embodiments.

FIG. 8 illustrates a crossbar switch according to some embodiments.

### DETAILED DESCRIPTION

Embodiments described may be associated with any type of “interconnect structure.” As used herein, the phrase “interconnect structure” may refer to, for example, a structure that includes one or more write ports and one or more read ports that can be used to store or exchange information. For example, an interconnect structure may be a memory structure, such as a register file or a cache structure. According to other embodiments, an interconnect structure may be associated with a crossbar switch or scoreboard.

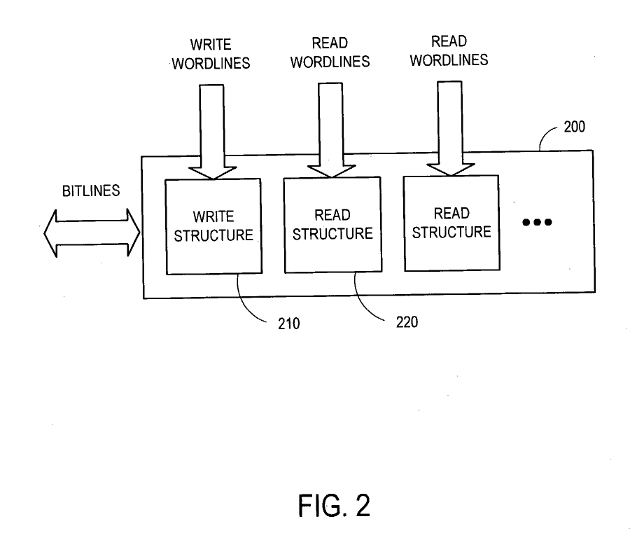

FIG. 2 is a block diagram of a memory structure 200 according to some embodiments. The memory structure 200 may be associated with, for example, a register file in a processor.

The memory structure 200 includes a write structure 210. In particular, the write structure 210 includes a write port for each of a plurality of information cells. Note that the write structure 210 may also include a storage element for each of the information cells.

The write structure 210 further includes write wordlines that may be used to store information in the memory structure 200 (e.g., to select a port for a particular information cell in the write structure 210). Moreover, the number of write wordlines may be based on the number of information cells. For example, a memory structure 200 with sixteen information cells may have a write structure 210 that is accessed via sixteen write wordlines.

The memory structure 200 also includes a plurality of read structures 220, and each read structure 220 may be associated with a different read port. For example, each read structure 220 may include a separate read port (e.g., P2) for each of the information cells. Each read structure 220 further includes read wordlines that are used to select a port for a particular information cell (e.g., for C2) when retrieving information from the memory structure 200. According to some embodiments, the number of read wordlines is less than the number of information cells. For example, the read wordlines may comprise multistage, stacked multiplex read wordlines. As a result, the total number of wordlines associated with the memory structure 200 may be reduced (as compared to a traditional design), resulting in a smaller array area.

Consider a memory structure 200 with sixteen information cells and three read ports. In this case, three read structures 220 may be used, and each read structure 200 might have four read wordlines (e.g., wordlines that are multiplexed to select one of the sixteen information cells). Note that this approach could be used with any number of information cells (e.g., 32, 64, 128, or 256 information cells).

Note that the memory structure 200 could, according to some embodiments, include a plurality of write structures 210 (not illustrated in FIG. 2) in addition to, or instead of, the plurality of read structures 220. Moreover, the number of write wordlines might be less than the number of information cells (e.g., the write wordlines may comprise multistage, stacked multiplex write wordlines).

The memory structure 200 also includes bitlines that may be used to store information into, or retrieve information from, the memory structure 200- and the number of bitlines may be based on the total number of write structures 210 and read structures 220. By way of example, a memory structure 200 with one write port and six read ports may have seven bitlines (i.e., one bitline that is used to provide information to the memory structure 200 and six bitlines that are used to receive information from the memory structure 200).

Note that, according to some embodiments, the read structures 220 are decoupled from the write structure 210. In this way, a set of building “blocks” (i.e., write structures 210 and read structures 220) may be created for designing register file structures. In addition, the same blocks may be re-used in designs that have different numbers of write and/or read ports.

Moreover, efficient packing of both the write structures 210 and the read structures 220 may be provided. For example, the small size of a write structure 210 may enable the stacking of several of such blocks. Similarly, the size of a read structure 220 may be small because: (i) the read MUX for multiple entries may be grouped together, (ii) the mutex nature of the read wordlines for one port may reduce the need for shielding wires, and (iii) the MUX in the read structure 220 may be implemented as a multistage, stacked MUX with wordlines shared across first stage MUXs while adding fewer wires to control the second stage MUX.

Note that as N read or write ports are added, it may be possible to stack additional write structures 210 and read structures 220 beneath the read bitline wires. As a result, the array may be folded to reduce its width without increasing its height beyond that which may be required by the read bitlines. The resulting array may grow as a function of N*log(N), where the log(N) factor is due to the logarithmic growth rate associated with adding control wires for a second stage MUX in the read structure 220 (or write structure 210). As compared to the traditional approach (which grows as a function of N*N), considerable area savings and speedup may be realized. Moreover, the basic building block elements (i.e., the write structure 210 and the read structures 220) may be tiled out to create complex memory structures (e.g., with any number of information cells, write ports, and/or read ports)—reducing the design time and expense associated with the memory structure design.

### EXAMPLE

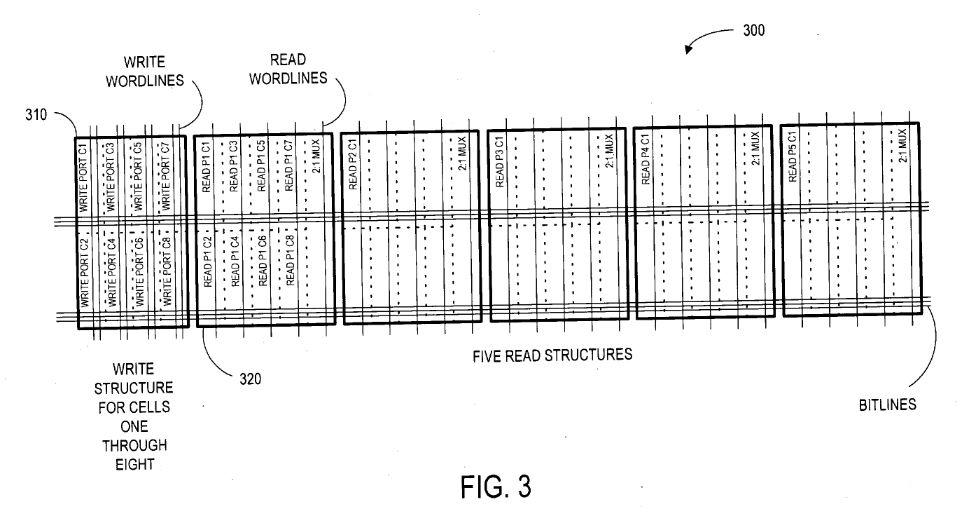

FIG. 3 is a diagram of a register file structure 300 according to some embodiments. In particular, the register file structure 300 has eight information cells, each information cell including one write port and five read ports.

The register file structure 300 includes a write structure 310 having a write port for each of the eight information cells (i.e., C1 through C8). Note that the write structure 310 may also include a storage element for each of the information cells.

The write structure 310 further includes eight write wordlines that may be used to select a particular information cell when storing information into the register file structure 300 (i.e., the write structure 310 has one write wordline for each of the eight information cells).

The register file structure 300 also includes five read structures 320 (i.e., one for each of the five read ports), each read structure 320 including a read port for each of the eight information cells. For example, the first read structure 320 includes read port P1 for each information cell (i.e., C1 through C8). Similarly, the second read structure includes read port P2 for each of C1 through C8.

Each read structure 320 further includes five multistage, stacked multiplex read wordlines that are used to select a particular information cell when retrieving information from the register file structure 300. In particular, the five read wordlines may be associated with an 8:1 MUX implemented via two 4:1 MUXs followed by a 2:1 MUX (with 4 wordlines shared across the two 4:1 MUXs). That is, one of the five read wordlines for a particular port (e.g., P2) may select between a first group of four information cells (e.g., C1, C3, C5, and C7) and a second group of four information cells (e.g., C2, C4, C6, and C8). The remaining four read wordlines would then be used to chose a particular information cell from within the selected group. Such an approach may provide a reduction in the number of read wordlines from eight (in the traditional approach) to five for each memory cell group.

The register file structure 300 also includes six bitlines that may be used to store information into, or receive information from, the register file structure 300 (e.g., one bitline provides information to the write structure 310 and each of the other five bitlines receive information from one of the read structures 320).

Methods

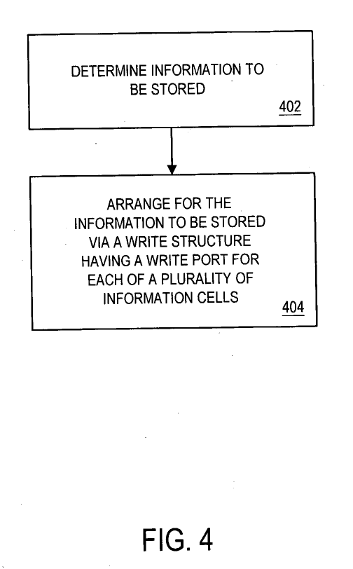

FIG. 4 is a flow chart of a method of storing information according to some embodiments. The flow charts described herein do not imply a fixed order to the actions, and embodiments may be practiced in any order that is practicable. The method may be associated with, for example, memory structure 200 illustrated in FIG. 2 and/or the register file structure 300 illustrated in FIG. 3.

At 402, information to be stored is determined. For example, a processor may determine that a particular bit of information needs to be stored into a particular memory structure cell.

At 404, it is arranged for the information to be stored via a write structure having a write port for each of a plurality of information cells. For example, the processor may select a particular write port via a write wordline and provide the information via a bitline.

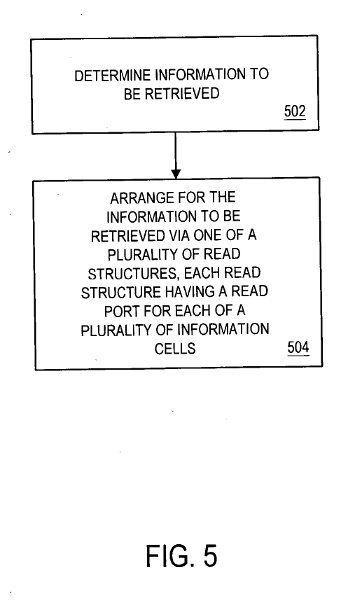

FIG. 5 is a flow chart of a method of retrieving information according to some embodiments. The method may be associated with, for example, memory structure 200 illustrated in FIG. 2 and/or the register file structure 300 illustrated in FIG. 3. At 502, information to be retrieved is determined. For example, a processor may determine that a particular bit of information needs to be retrieved from a particular memory structure cell.

At 504, it is arranged for the information to be retrieved via one of a plurality of read structures, each read structure having a read port for each of a plurality of information cells. Consider, for example, the case when information will be accessed via the first read port of the fourth information cell in the file register structure 300 illustrated in FIG. 3. In this case, one read wordline would be used to select the bottom row of the first read structure 320 (i.e., associated with C2, C4, C6, and C8). The remaining four read wordlines would be used to select the second column (i.e., associated with C4).

Integrated Circuit

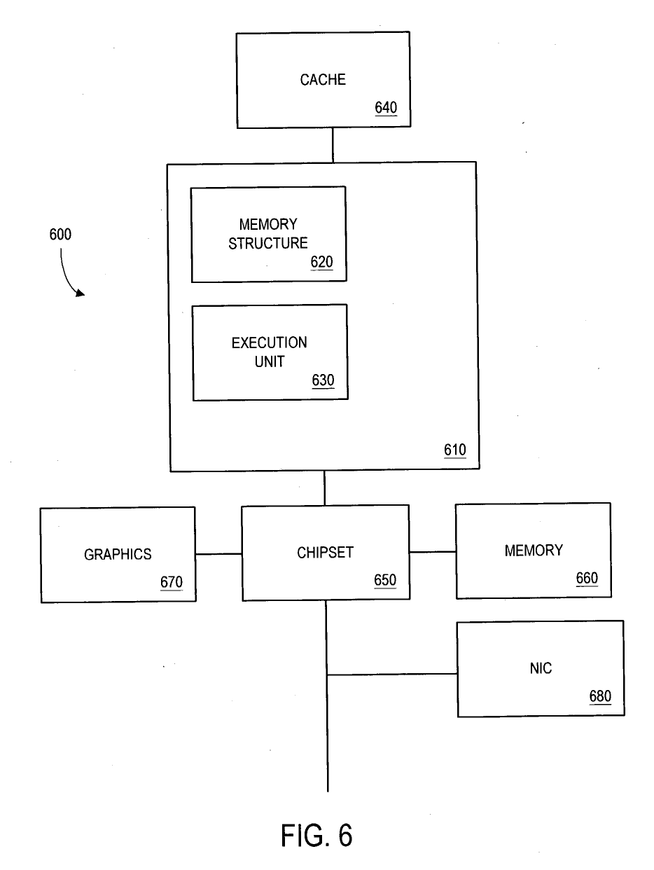

FIG. 6 is a block diagram of a system 600 that includes an integrated circuit 610 with a memory structure 620 according to some embodiments. The integrated circuit 610 may also include other units, such as an execution unit 630, that store information into, or receive information from, the memory structure 620. Note that the memory structure 620 may be a register file structure, a cache structure, or another type of memory structure. Moreover the integrated circuit 610 may be a processor or another type of integrated circuit. According to some embodiments, the integrated circuit 610 also communicates with an off-die cache 640. The integrated circuit 610 may also communicate with a system memory 660 via a host bus and a chipset 650. In addition, other off-die functional units, such as a graphics accelerator 670 and a Network Interface Controller (NIC) 680 may communicate with the integrated circuit 610 via appropriate busses.

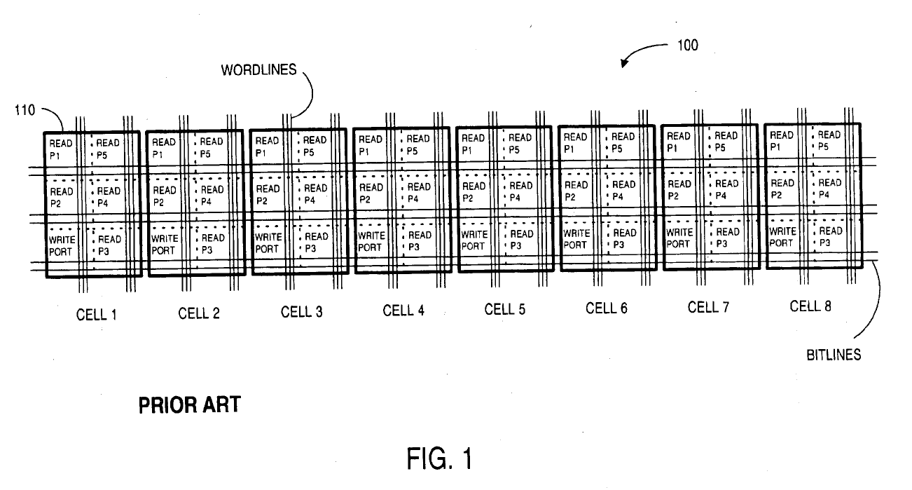

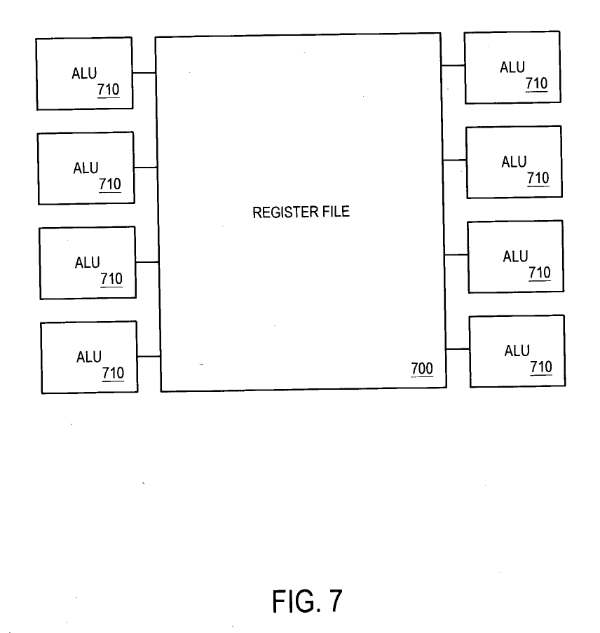

According to some embodiments, the techniques described herein allow for improved circuit designs. For example, FIG. 7 illustrates a register file 700 and associated Arithmetic-Logic Units (ALUs) 710 according to some embodiments. In this case, the register file 700 may comprise a structure such as the one described with respect to FIG. 2 or 3 and, as a result, up to eight ALUs 710 are able to access the register file 700 (e.g., because of the reduced number of write and/or read wordlines associated with the register file 700). In contrast, a register file designed according to traditional approaches (e.g., as described with respect to FIG. 1), might only be accessible by four ALUs.

Crossbar Switch

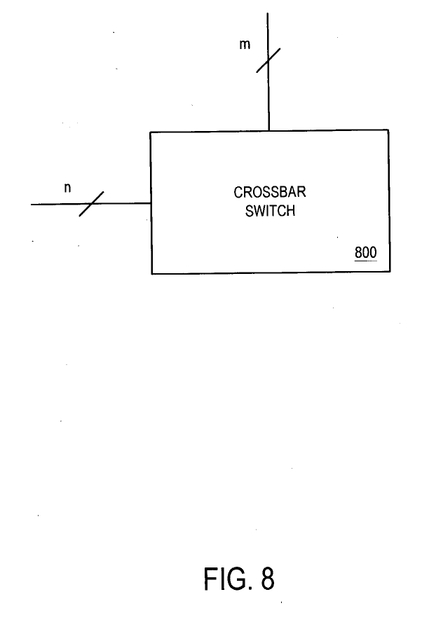

Although previous examples have been associated with register file designs, embodiments may be practiced with any type of interconnect structure. For example, FIG. 8 illustrates a crossbar switch 800 according to some embodiments. The crossbar switch 800 may exchange information via a set of n source wires and a set of m destination wires (e.g., similar to write ports and read ports). In this case, the same multiplex approach described with respect to FIGS. 2 and 3 may be used for the source wires and/or the destination wires. As a result, the area of the crossbar switch 800 may grow as a function of m*log(n) or n*log(m)—or even log(m)*log(n)—as opposed to n*m as with traditional designs.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although embodiments have been described with respect a particular number of information cells, write ports, and read ports, such an approach may be used to implement memory structures having any number of information cells, write ports, and/or read ports. For example, multiplexed write wordlines may be used to select a particular information cell for a particular write port and/or multiple write structures may be used.

Moreover, other types of multiplexing stages and stacks may be used. Consider, for example, a memory structure having sixteen information cells. In this case, a 16:1 MUX for an read structure may be implemented via two 8:1 MUXs followed by a 2:1 MUX. As another approach, four 4:1 MUXs might be followed by another 4:1 MUX.

In addition, although particular interconnect structures have be illustrated, embodiments may be used with respect to any type of interconnect structure. For example, a micro-code Read Only Memory (ROM) structure may be designed using the approach described herein (e.g., and the structure may be similar to a register file without any write ports).

Further, although software or hardware may have been described as performing particular functions, such functions could be performed using either software or hardware—or a combination of software and hardware (e.g., a medium may store instructions adapted to be executed by a processor to perform a method of designing or using memory structures).

The several embodiments described herein are solely for the purpose of illustration. Persons skilled in the art will recognize from this description other embodiments may be practiced with modifications and alterations limited only by the claims.

What is claimed is:

1. An interconnect structure, comprising:
a write structure having a write port for each of a plurality of information cells; and
a plurality of read structures, each read structure having a read port for each of the information cells.

2. The interconnect structure of claim 1, further comprising:
bitlines associated with said write structure and said read structures.

3. The interconnect structure of claim 2, wherein the number of bitlines is based on the number of write structures and read structures.

4. The interconnect structure of claim 1, wherein said write structure further includes:
write wordlines.

5. The interconnect structure of claim 4, wherein the number of write wordlines is based on the number of information cells.

6. The interconnect structure of claim 1, wherein said write structure further includes:
a storage element for each information cell.

7. The interconnect structure of claim 1, wherein each read structure further includes:
read wordlines.

8. The interconnect structure of claim 7, wherein the number of read wordlines is less than the number of information cells.

9. The interconnect structure of claim 8, wherein said read wordlines comprise multistage, stacked multiplex read wordlines.

10. The interconnect structure of claim 9, wherein: (i) the memory structure is associated with eight information cells, one write port, and five read ports, and (ii) said read wordlines comprise 8:1 multiplexing via two 4:1 multiplexers and a 2:1 multiplexer.

11. The interconnect structure of claim 1, wherein said read structures are decoupled from said write structure.

12. The interconnect structure of claim 1, wherein the interconnect structure is associated with a superscalar processor.

13. The interconnect structure of claim 1, wherein the interconnect structure is associated with at least one of: (i) a memory structure, (ii) a register file, (iii) a crossbar switch, and (iv) a scoreboard.

14. The interconnect structure of claim 1, wherein the interconnect structure is a cache structure.

15. An interconnect structure, comprising:
a plurality of write structures, each write structure having a write port for each of a plurality of information cells; and
a read structure having a read port for each of the information cells.

16. The interconnect structure of claim 15, wherein the interconnect structure is associated with at least one of: (i) a memory structure, (ii) a register file, (iii) a crossbar switch, and (iv) a scoreboard.

17. An interconnect structure, comprising:
a plurality of write structures, each write structure having a write port for each of a plurality of information cells; and
a plurality of read structures, each read structure having a read port for each of the information cells.

18. The interconnect structure of claim 17, wherein the interconnect structure is associated with at least one of: (i) a memory structure, (ii) a register file, (iii) a crossbar switch, and (iv) a scoreboard.

19. A method of storing information, comprising:
determining information to be stored; and
arranging for the information to be stored via a write structure having a write port for each of a plurality of information cells.

20. The method of claim 19, wherein said arranging is performed via bitlines and write wordlines.

21. A method of retrieving information, comprising:
determining information to be retrieved; and
arranging for the information to be retrieved via one of a plurality of read structures, each read structure having a read port for each of a plurality of information cells.

22. The method of claim 21, wherein said arranging is performed via bitlines and read wordlines.

23. A system, comprising:
a chipset; and
a die comprising a microprocessor in communication with the chipset, wherein the microprocessor includes a register file comprising:
a write structure having a write port for each of a plurality of information cells, and
a plurality of read structures, each read structure having a read port for each of the information cells.

24. The system of claim 23, wherein:
said register file is associated with a number of bitlines based on the number of write structures and read structures,
said write structure includes a memory storage element for each information cell and a number of write wordlines based on the number of information cells, and
each read structure includes a number of multistage, stacked multiplex read wordlines.
